(19) United States
(12) Patent Application Publication
(10) Pub. No.: US 2016/0253628 A1
(43) Pub. Date: Sep. 1, 2016

(54) PRESENTING A CONTEXTUAL MULTI-CHANNEL CONTACT PRESENCE

(71) Applicant: COMVERSE, LTD., Raanana (IL)

(72) Inventors: Omer URETZKY, Ramat Hasharon (IL); Noga AMIT, Beer Yaacov (IL); Amit BRAYTENBAUM, Lehavim (IL)

(21) Appl. No.: 15/053,684

(22) Filed: Feb. 25, 2016

Related U.S. Application Data
(60) Provisional application No. 62/121,535, filed on Feb. 27, 2015.

(51) Int. Cl. G06Q 10/10; H04L 29/08

(52) U.S. Cl. CPC G06Q 10/1093; H04L 67/24

(57) ABSTRACT

There is provided a method for presenting on a communication device of a user, multi-channel presence information concerning a contact of the user. The method includes (a) obtaining a first score that indicates an availability of the contact to accept a communication via a first channel of communication, and a second score that indicates an availability of the contact to accept a communication via a second channel of communication, (b) determining, based on the first score and the second score, a preference between the first channel and the second channel, and (c) presenting the preference on the communication device of the user. There is also provided a system that performs the method, and a storage device that contains instructions that cause a processor to perform the method.

### CROSS-REFERENCED APPLICATION

This application claims priority to U.S. Provisional Application No. 62/121535, filed on Feb. 27, 2015, which is incorporated herein in its entirety by reference.

### BACKGROUND OF THE DISCLOSURE

1. Field of the Disclosure

The present disclosure relates to presentation of information on a display of a user device. More particularly, the present disclosure relates to a presentation of a contact's availability or likelihood to engage in a communication by way of a particular channel or mode of communication, e.g., text, voice, video, or face-to-face.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

A user of a device, such as a mobile telephone or a computer tablet, will typically have a plurality of contacts with whom the user communicates. In computer and telecommunications networks, presence information is a status indicator that conveys ability and willingness of a party having a communication device, to communicate with another. The party may publish a presence state to indicate his current communication status, which informs others that wish to contact the party of his availability and willingness to communicate. A common technique of publicizing presence today is to display an indicator icon on an instant messaging client, typically from a choice of graphic symbols with easy-to-convey meanings, and a list of corresponding text descriptions of each of the states. Exemplary states of the party's availability are “free for chat”, “busy”, “away”, “do not disturb”, and “out to lunch”. Such states exist in many variations across different modern instant messaging clients.

Existing presence solutions do not take into consideration contextual availability of a party based on parameters such as location, time, schedule, battery level, etc. In addition, the existing solutions do not reflect different availability of the party across channels, for example, if the party is currently driving he might be available for a voice call but not for a video call or a text message. Further, the purpose of the communication might be relevant during work hours but not during private time or vice versa.

There is a need for a technique that evaluates the availability of a contact based on these factors to determine a likelihood that the contact will accept or engage in a communication by way of a particular channel.

### SUMMARY OF THE DISCLOSURE

Ordinarily, availability of a party may vary between channels (e.g., text, voice or video, face-to-face), between times of day, and between other contextual factors. The technique presented herein calculates a presence of the party for each of the channels and indicates which of the channels the contact is most likely to prefer. The technique is suitable for a professional, i.e., work-related, environment, but can be adapted for use in social contexts.

There is provided a method for presenting on a communication device of a user, multi-channel presence information concerning a contact of the user. The method includes (a) obtaining a first score that indicates an availability of the contact to accept a communication via a first channel of communication, and a second score that indicates an availability of the contact to accept a communication via a second channel of communication, (b) determining, based on the first score and the second score, a preference between the first channel and the second channel, and (c) presenting the preference on the communication device of the user. There is also provided a system that performs the method, and a storage device that contains instructions that cause a processor to perform the method.

### BRIEF DESCRIPTION OF THE DRAWINGS

FIG. 1 is a block diagram of a system for employment of the technique disclosed herein.

FIG. 2 is a block diagram of a process performed by a server module in the system of FIG. 1.

FIG. 3 is an illustration of a user contact screen in the system of FIG. 1, showing an example of a visual representation of a contact's presence and a preferred channel for the contact.

### DESCRIPTION OF THE DISCLOSURE

The technique presented herein collects, on behalf of a user of a communication device, various contextual information about a contact of the user, such as the contact's mobile phone reception level, location, whether the contact is driving, and time, and based on the collected contextual information, determines the availability of the contact for a communication by way of a plurality channels, for example:
(1) text, e.g., chat;
(2) voice call;
(3) video; and
(4) a face-to-face (F2F) meeting.

For each channel of communication, the technique calculates the availability of the contact by giving weights to different contextual factors. The technique then presents the user with a visualization of the contact's presence and preferred channel. Alternatively, the technique presents the user with a visualization of the contact's presence and a visualized ranking of a plurality of communication channels from which the user can select a channel for a communication.

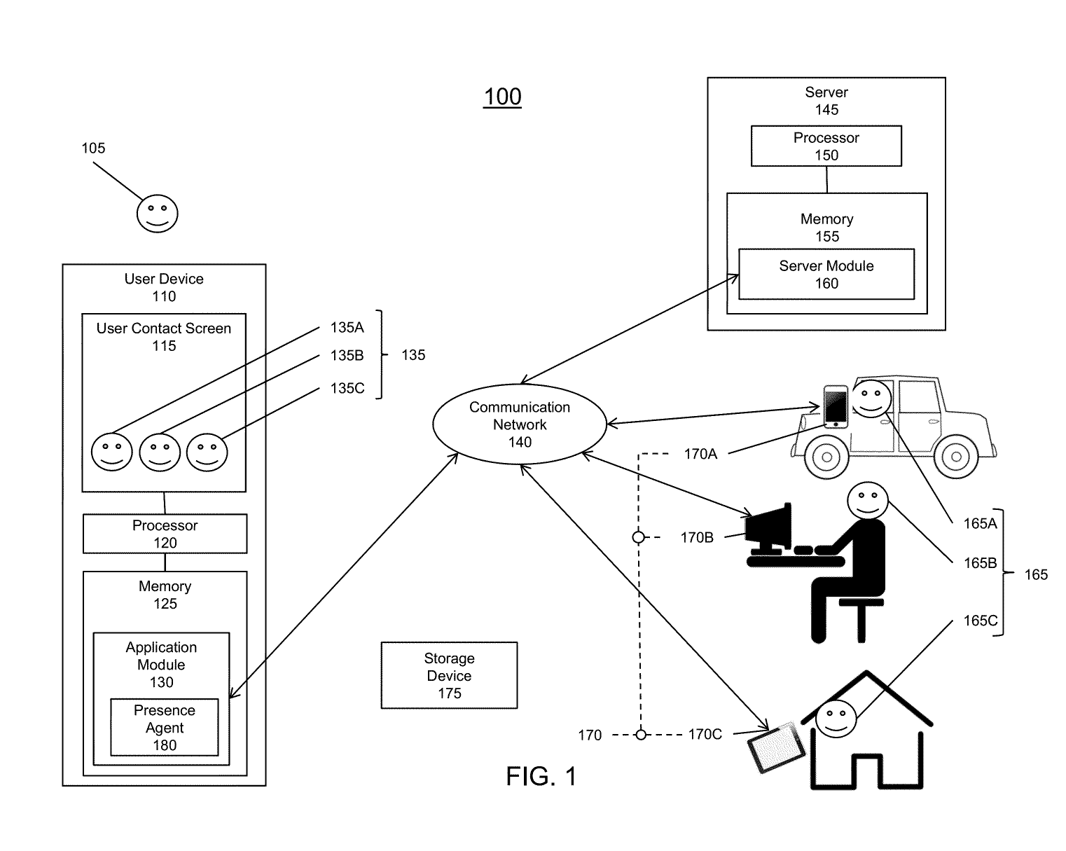

Referring to FIG. 1, a system according to the present disclosure is generally represented by reference numeral 100. System 100 includes a user device 110, contact devices 170A, 1706 and 170C, and a server 145, all of which are coupled to a communication network 140 for communication with one another.

Communication network 140 is a data communications network and can include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, or (f) the Internet. Communications over communication network 140 are conducted by way of electronic signals and optical signals.

User device 110 is operated by a user 105. Contacts 165A, 1656 and 165C are contacts of user 105. Contact devices 170A, 1706 and 170C are operated by contacts 165A, 165B and 165C, respectively. Contact devices 170A, 170B and 170C are collectively referred to as contact devices 170. Contacts 165A, 165B and 165C are collectively referred to as contacts 165. Although FIG. 1 shows three contacts 165 and three contact devices 170, in practice, there can be any number of contacts 165 and contact devices 170.

User device 110 is a communication device, e.g., a telephone or a computer, and includes a user contact screen 115, a processor 120, and a memory 125.

User contact screen 115 is a display, and in FIG. 1, is shown as displaying representations 135A, 1356 and 135C of contacts 165A, 1656 and 165C, respectively. Representations 135A, 135B and 135C are collectively referred to as representations 135.

Processor 120 is an electronic device configured of logic circuitry that responds to and executes instructions.

Memory 125 is a tangible, non-transitory, computer-readable storage medium encoded with a computer program. In this regard, memory 125 stores data and instructions, i.e., program code, that are readable and executable by processor 120 for controlling the operation of processor 120. Memory 125 can be implemented in a random access memory (RAM), a hard drive, a read only memory (ROM), or a combination thereof. One component of memory 125 is an application module 130.

Application module 130 has or contains instructions for controlling processor 120 to execute operations described herein. For example, under control of application module 130, processor 120 enables user 105 to use application module 130 to communicate with contacts 165, and more generally, all contacts, i.e., people and groups, who are listed in a contact list (not shown). Application module 130 calculates a contextual and multi-channel presence for each contact 165 and determines corresponding representations 135 to be presented on user contact screen 115. When user 105 opens user contact screen 115, processor 120 requests, from application module 130, information about each contact 165, and presents the information, or a subset thereof, on user contact screen 115. Application module 130 also runs a presence agent 180 that collects, and sends to server module 160, parameters that might affect user 105′s presence.

In the present document, although operations are described as being performed by user device 110, or by application module 130 or its subordinate modules, the operations are actually being performed by processor 120. The term “module” is used herein to denote a functional operation that can be embodied either as a stand-alone component or as an integrated configuration of a plurality of subordinate components. Thus, application module 130 can be implemented as a single module or as a plurality of modules that operate in cooperation with one another. Moreover, although application module 130 is described herein as being installed in memory 125, and therefore being implemented in software, it could be implemented in any of hardware (e.g., electronic circuitry), firmware, software, or a combination thereof.

Contact devices 170 are communication devices with features similar to those of user device 110. Thus, each of contact devices 170A, 1706 and 170C also includes a processor and a memory having a version of presence agent 180 that collects, and sends to server module 160, parameters that might affect the presence of contacts 165A, 1656 and 165C, respectively.

Server 145 includes a processor 150, and a memory 155. Processor 150 is an electronic device configured of logic circuitry that responds to and executes instructions. Memory 155 is a tangible, non-transitory, computer-readable storage medium encoded with a computer program. In this regard, memory 155 stores data and instructions, i.e., program code, that are readable and executable by processor 150 for controlling the operation of processor 150. Memory 155 can be implemented in a random access memory (RAM), a hard drive, a read only memory (ROM), or a combination thereof. One of the components of memory 155 is a server module 160.

Server module 160 has or contains instructions for controlling processor 150 to execute operations described herein. For example, under control of server module 160, processor 150 calculates parameters that reflect the presence of contacts 165 according to their current context. Server 145 is invoked by predefined recognized context changes of contacts 165, for example, contact 165B entering a meeting. In addition, server 145 is invoked periodically in a batch mode.

In the present document, although operations are described as being performed by server 145, or by server module 160 or its subordinate modules, the operations are actually being performed by processor 150. Also, although server 145 is represented herein as a standalone device, it is not limited to such, but instead can be coupled to other devices (not shown) in a distributed processing system.

While application module 130 is indicated as being already loaded into memory 125, and while server module 160 is indicated as being already loaded into memory 155, either or both of them can be configured on a storage device 175 for subsequent loading into memories 125 and 155. Storage device 175 is a tangible, non-transitory, computer-readable storage device. Examples of storage device 175 include a compact disk, a magnetic tape, a read only memory, an optical storage medium, a hard drive or a memory unit consisting of multiple parallel hard drives, and a universal serial bus (USB) flash drive. Alternatively, storage device 175 can be a random access memory, or other type of electronic storage device, located on a remote storage system and coupled to user device 110 and server 145 via communication network 140.

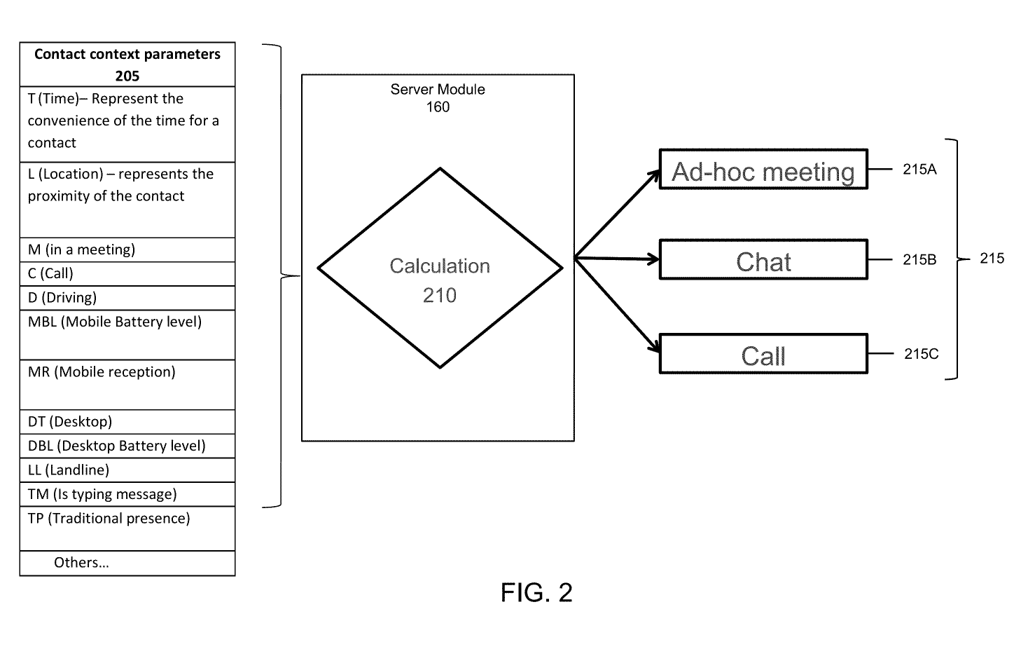

Referring to FIG. 2, a process performed by server module 160, in which contact context parameters 205 are harvested from various resources, is shown. TABLE A, below, shows exemplary parameters that can be considered, their different values, optional resources or sources of data, and a default value when data is not otherwise available. In practice, the operation of server module 160 is not limited to processing these particular parameters.

TABLE A
Exemplary Parameters

| | | | Default |
|---|---|---|---|
| | | | (when |
| | | | no data is |
| Parameter | Values | Optional resources | available) |
| T (Time): | Work hours: T = 1 | User time zone: | Time zone |
| Represent | End of work hours | geo-location | will be |
| the | (less than 15 | Wi-Fi info | taken |
| convenience | minutes): T = 0.7 | Flights info | from |
| of the time | Afternoon hours: | Calendar | mobile/ |
| for a contact | T = 0.5 | Cellular network | desktop |
| | Evening: T = 0.3 | Working hour/days: | config- |
| | Weekends: T = 0.2 | Configurable by user | uration, |
| | Holidays: T = 0.1 | History patterns | or from |
| | Sleep hours: T = 0 | Scheduled meetings | contact |
| | | | address. |
| | | | Working |
| | | | hours |
| | | | will be |
| | | | Mon-Fri |
| | | | 8:00-17:00 |
| L (Location): | Office (proximity) : | Rich Communication | L = 0.5 |
| represents | L = 1 | Services (RCS) | |
| the proximity | Nearby/On the way | location | |
| of the | to office: L = 0.5 | Cellular location | |
| contact | Elsewhere: 0.2 | Wi-Fi | |
| | A broad: L = 0 | Global Positioning | |
| | | System (GPS) data | |
| M (in a | In a meeting: M = 1 | Traditional presence | M = 0.1 |
| meeting) | Less than 10 | Calendar on contact | |
| | minutes to the next | device | |
| | meeting: M = 0.7 | Online calendar | |
| | Otherwise: M = 0 | 3^{rd} party calendar | |
| C (Call) | On call: C = 1 | Mobile device | C = 0.2 |
| | Not on call: C = 0 | Landline | |
| | | Traditional presence | |
| D (Driving) | Currently driving: | Location data delta, | D = 0.05 |
| | D = 1 | i.e., change, per time | |
| | Not driving: D = 0 | (based on location | |
| | | parameter data) | |
| | | Mobile operating | |
| | | system (OS) | |
| | | driving platform | |
| | | 3^{rd} party application | |
| | | program interface | |
| | | (API) traffic and | |
| | | navigation | |
| | | application | |
| MBL (Mobile | Connected to | Mobile device | MBL = 1 |
| Battery level) | charger: MBL = 1 | | |
| | Otherwise: MBL = | | |
| | % of remaining | | |
| | power | | |
| MR (Mobile | MR = % of | Mobile device, and/or | MR = 1 |
| reception) | reception | from communication | |
| | | service provider | |
| | | (CSP) systems | |
| DT (Desktop) | Active in the last 15 | Desktop | DT = 1 |
| | minutes: DT = 1 | Network activity | |
| | Away: DT = 0.5 | originated from | |
| | Logged | desktop Traditional | |
| | off/disconnected: 0 | presence | |
| DBL | Connected to | Desktop | DBL = 1 |
| (Desktop | charger: DBL = 1 | | |
| Battery level) | Otherwise: DBL = | | |
| | % of remaining | | |
| | power | | |
| LL (Landline) | Desktop in docking | Desktop | LL = 0.2 |
| | station: LL = DT | Network data | |
| | Last voice call from | | |
| | landline accrued t | | |
| | minutes ago and | | |
| | t < 60: | | |
| | $LL = 1 - \frac{t}{60}$ | | |
| TM (Is typing | Is typing: TM = 1 | RCS presence | TM = 0 |
| message) | User sent last | Mobile | |
| | message t minutes | Desktop | |
| | ago: | Network data | |
| | $TM = 1 - \frac{t}{60}$ | | |
| TP | Available: TP = 1 | Presence server | TP = 0.7 |
| (Traditional | Away: TP = 0.7 | (such as | |
| presence): | Busy: TP = 0.3 | an RCS presence | |
| | Do not disturb: | server) | |
| | TP = 0.1 | 3^{rd} parties | |
| | | such as unified | |
| | | communication | |
| | | clients and social | |
| | | media networks | |

In server module 160, a calculation 210 derives the presence of a contact for each of communication channels 215A, 215B and 215C, i.e., for an ad-hoc face-to-face meeting, chat, and a voice call, respectively. Communication channels 215A, 215B and 215C are collectively referred to as communication channels 215.

Calculation 210 gives different weights to different context parameters according to communication channel 215A, 215B or 215C. Thus, for each contact in user 105's contacts list, calculation 210 calculates a score that indicates a likelihood of the contact to respond through each of communication channels 215A, 215B and 215C. Please note that for minimizing the processing burden placed upon calculation 210, server module 160 will use optimization techniques, such as only calculating a delta, based on a changed parameter.

For example, using parameters from TABLE A, the likelihood for an ad-hoc F2F meeting is calculated as:

P_{FF}=T×L×(1−M)×(1−0.5C)×TP

Using parameters from TABLE A, the likelihood for chat is calculated as:

P_{C}=max{TM, (1−D)×T×(1−0.5M)×(1−0.5C)×TP×max[1.5×DT×DBL, MR×MBL]}

Using parameters from TABLE A, the likelihood for a voice call is calculated as:

Pᵥ=T×(1−M)×(1−0.7C)×TP×max[LL, MR×MBL]

For example, Dave is one of Hanna's colleagues and is currently driving home. Hanna wants to update him of a project status. Since Dave is currently driving, D=1, and the likelihood of Dave communicating through chat would be:

P_{C}=max{TM, (1−D)×T×(1−0.5M)×(1−0.5C)×TP×max[1.5×DT×DBL, MR×MBL]}=max{0, (1−1)× . . . }=0

The likelihood of Dave accepting a voice call would be:

$${P}_{V} = T \times ( 1 - M ) \times ( 1 - 0.7 C ) \times TP \times max [ LL , MR \times MBL ] = 0.5 \times ( 1 - 0 ) \times ( 1 - 0.7 \times 0 ) \times 0.7 \times max [ 0 , 1 \times 1 ] = 0.5 \times 0.7 = 0.35$$

Thus, as indicated above, the likelihood of Dave communicating through chat would be 0, and the likelihood of Dave accepting a voice call would be 0.35. Accordingly, system 100 would inform Hanna that the voice channel, i.e., communication channel 215C, is better than the chat channel, i.e., communication channel 215B. The fact that Dave is driving can be determined by a status indication provided by Dave, or can be based on location data delta, i.e., change, per time, as indicated in Table A above. The location data delta is, in turn, based on location parameter data that can be determined by changes in Global Positioning System (GPS) data. Moreover, the location data delta can also be used to indicate that Dave, for example, has stopped driving or is proceeding at a delta that is slow enough to support an assumption that Dave is walking.

The following is an example that does not include the driving parameter, but assumes that Dave's telephone has only 40% battery power remaining. The likelihood of Dave communicating through chat would be:

$${P}_{C} = max \{ TM , ( 1 - D ) \times T \times ( 1 - 0.5 M ) \times ( 1 - 0.5 C ) \times TP \times max [ 1.5 \times DT \times DBL , MR \times MBL ] \} = max \{ 0 , ( 1 - 0 ) \times 0.5 \times ( 1 - 0.5 \times 0 ) \times ( 1 - 0.5 \times 0 ) \times max [ 1.5 \times 0 \times 1 , 1 \times 0.4 \} = 0.5 \times 0.4 = 0.2$$

The likelihood of Dave accepting a voice call would be:

$${P}_{V} = T \times ( 1 - M ) \times ( 1 - 0.7 C ) \times TP \times max [ LL , MR \times MBL ] = 0.5 \times ( 1 - 0 ) \times ( 1 - 0.7 \times 0 ) \times 0.7 \times max [ 0.1 \times 0.4 ] = 0.5 \times 0.7 \times 0.4 = 0.14$$

Thus, in this example, the chat channel 215B (likelihood=0.2) is slightly preferred over the voice channel 215C (likelihood=0.14). In this instance, only the chat channel 2158 can be displayed for selection on Hanna's display, or both the chat channel 215B and voice channel 215C can be displayed on Hanna's device, with or without an indication of the relative scores.

The likelihoods that are calculated by calculation 210 do not necessarily represent an actual mathematical probability that a contact is likely to accept a call via a particular channel. For example, it is not necessarily true that a likelihood of 0.2 means a 20% chance of accepting a communication. Instead, the results of the calculations can be designated as scores, and considered in relation to one another, where the channel having the greatest score is designated as the preferred channel.

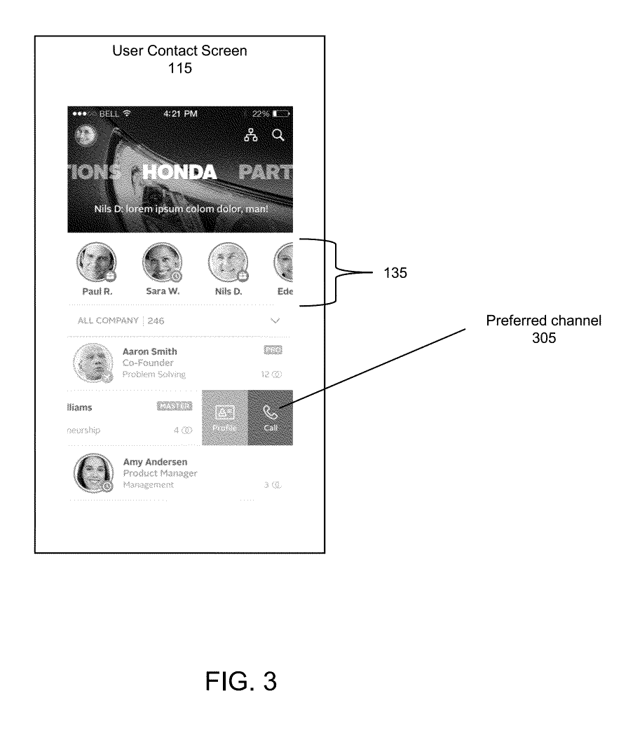

FIG. 3 shows a user contact screen 115 with an example of a visual representation of a contact's presence and a preferred channel 305 for the contact. In this visualization, user 105 will see the presence visualization on a contact record, and preferred channel 305 is presented when user 105 uses a swipe gesture on the contact record. Here, for a particular contact, the contact's preferred channel 305 is for a call, and is being presented by way of a visual feature that states “call”. Note that in FIG. 3, the quantity of information that is available for presentation on user contact screen 115 is more than can be displayed at one time. As such, user 105 would need to scroll left or right, or up or down, to view more of the information.

Other implementations and visualizations on user contact screen 115 can be employed. For example, all of a contact's channels could be represented on user contact screen 115, and for each channel, the contact's likelihood could be represented by way of (a) a numeric ranking, where each of the channels is given a ranking and the number “1” is assigned to the preferred channel, (b) a size ranking, where each of the channels is represented by an icon, and the icon of the preferred channel is bigger than that of the other channels, (c) a color ranking, where each of the channels is represented by a colored feature, and the feature for the preferred channel has a color that distinguishes it from that of the other channels, or (d) an intensity or shading ranking, where each of the channels is represented by a feature having an intensity or shading, and the feature for the preferred channel has an intensity or shading that distinguishes it from that of the other channels.

Although the present disclosure discusses communication channels for text, voice, video, and F2F, and in FIG. 2 shows three communication channels 215, in practice, system 100 is not limited to any particular mode of communication or number of communication channels 215. For example, system 100 could be employed to evaluate just two channels, e.g., text and voice, or four channels, e.g., text, voice, video and F2F.

System 100 is modular, flexible, and can be adjusted to specific needs. For example, calculation 201 can be adjusted to different needs of presence calculations, such as calculating the availability of social groups for a group chat, a conference voice call or a meeting. Also, similar methods can be used for calculating the availability of parties for a video conference, and the like. New parameters can be easily aggregated into calculation 201. For example, if the noise level of the contact environment is available as part of contact context parameters 205, it can be used by calculation 210 as part of the calculation of voice call availability.

Also, operations described herein for application module 130 and server module 160 need not be partitioned between server 145 and user device 110 as shown in FIG. 1. All or some of the operations of application module 130 and server module 160 can be performed by user device 110, and all or some of the operations of application module 130 and server module 160 can be performed by server 145. That is, the operations of application module 130 and server module 160 can be distributed between user device 110 and server 145. Thus, processor 120 and processor 150, together, can be regarded as a processor, and memory 125 and memory 155, together, can be regarded as a memory.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having plural articles.

What is claimed is:

1. A method for presenting on a communication device of a user, multi-channel presence information concerning a contact of said user, the method comprising:
obtaining a first score that indicates an availability of said contact to accept a communication via a first channel of communication, and a second score that indicates an availability of said contact to accept a communication via a second channel of communication;
determining, based on said first score and said second score, a preference between said first channel and said second channel;
presenting said preference on said communication device of said user.

2. The method of claim 1, further comprising, prior to said obtaining:
receiving data that indicates information concerning a context of said contact;
applying a value to a parameter, based on said data, thus yielding a valued parameter; and
calculating said first score and said second score, based on said valued parameter.

3. The method of claim 2, wherein said parameter is selected from the group consisting of:
time where said contact is located;
location of said contact;
whether said contact is in a meeting;
a time to a next scheduled meeting for said contact;
whether said contact is presently on call; and
whether said contact is presently driving.

4. The method of claim 1, further comprising, prior to said receiving:
receiving data that indicates information concerning a context of a communication device of said contact;
applying a value to a parameter, based on said data, thus yielding a valued parameter; and
calculating said first score and said second score, based on said valued parameter.

5. The method of claim 4, wherein said parameter is selected from the group consisting of:
a battery power level of said communication device of said contact;
a mobile reception level of said communication device of said contact;
a condition of said communication device of said contact, wherein said communication device of said contact is a desktop computer;
a condition of said communication device of said contact, wherein said communication device of said contact is a landline device; and
a time a message was last typed on said communication device of said contact.

6. A system for presenting on a communication device of a user, multi-channel presence information concerning a contact of said user, the system comprising:
a processor; and
a memory that contains instructions that are readable by said processor to cause said processor to perform actions of:
obtaining a first score that indicates an availability of said contact to accept a communication via a first channel of communication, and a second score that indicates an availability of said contact to accept a communication via a second channel of communication;
determining, based on said first score and said second score, a preference between said first channel and said second channel;
presenting said preference on said communication device of said user.

7. The system of claim 6, wherein said instructions, prior to said obtaining, also cause said processor to perform actions of:
receiving data that indicates information concerning a context of said contact;
applying a value to a parameter, based on said data, thus yielding a valued parameter; and
calculating said first score and said second score, based on said valued parameter.

8. The system of claim 7, wherein said parameter is selected from the group consisting of:
time where said contact is located;
location of said contact;
whether said contact is in a meeting;
a time to a next scheduled meeting for said contact;
whether said contact is presently on call; and
whether said contact is presently driving.

9. The system of claim 6, wherein said instructions, prior to said obtaining, also cause said processor to perform actions of:
receiving data that indicates information concerning a context of a communication device of said contact;
applying a value to a parameter, based on said data, thus yielding a valued parameter; and
calculating said first score and said second score, based on said valued parameter.

10. The system of claim 9, wherein said parameter is selected from the group consisting of:
a battery power level of said communication device of said contact;
a mobile reception level of said communication device of said contact;
a condition of said communication device of said contact, wherein said communication device of said contact is a desktop computer;
a condition of said communication device of said contact, wherein said communication device of said contact is a landline device; and
a time a message was last typed on said communication device of said contact.

11. A non-transitory storage device for presenting on a communication device of a user, multi-channel presence information concerning a contact of said user, the non-transitory storage device comprising instructions that are readable by a processor to cause said processor to perform actions of:
obtaining a first score that indicates an availability of said contact to accept a communication via a first channel of communication, and a second score that indicates an availability of said contact to accept a communication via a second channel of communication;
determining, based on said first score and said second score, a preference between said first channel and said second channel;
presenting said preference on said communication device of said user.

12. The non-transitory storage device of claim 11, wherein said instructions, prior to said obtaining, also cause said processor to perform actions of:
receiving data that indicates information concerning a context of said contact;
applying a value to a parameter, based on said data, thus yielding a valued parameter; and
calculating said first score and said second score, based on said valued parameter.

13. The non-transitory storage device of claim 12, wherein said parameter is selected from the group consisting of:
time where said contact is located;
location of said contact;
whether said contact is in a meeting;
a time to a next scheduled meeting for said contact;
whether said contact is presently on call; and
whether said contact is presently driving.

14. The non-transitory storage device of claim 11, wherein said instructions, prior to said obtaining, also cause said processor to perform actions of:
receiving data that indicates information concerning a context of a communication device of said contact;
applying a value to a parameter, based on said data, thus yielding a valued parameter; and
calculating said first score and said second score, based on said valued parameter.

15. The non-transitory storage device of claim 14, wherein said parameter is selected from the group consisting of:
a battery power level of said communication device of said contact;
a mobile reception level of said communication device of said contact;
a condition of said communication device of said contact, wherein said communication device of said contact is a desktop computer;
a condition of said communication device of said contact, wherein said communication device of said contact is a landline device; and
a time a message was last typed on said communication device of said contact.
